(19) United States
(12) Patent Application Publication
(10) Pub. No.: US 2022/0097216 A1
(43) Pub. Date: Mar. 31, 2022

(54) SLEEVE

(71) Applicant: KABO TOOL COMPANY, Taichung City (TW)

(72) Inventor: Chih-Ching HSIEH, Taichung City (TW)

(21) Appl. No.: 17/444,288

(22) Filed: Aug. 3, 2021

Related U.S. Application Data
(60) Provisional application No. 63/084,576, filed on Sep. 29, 2020.

(51) Int. Cl. B25B 23/00; B25B 13/06

(52) U.S. Cl. CPC B25B 23/0035; B25B 13/06

(57) ABSTRACT

A sleeve is provided and includes a sleeve body, at least two grooves and at least two ring elements. The sleeve body has a central axis and includes an opening and a tooth structure. The tooth structure is disposed around an inner wall of the sleeve body. The at least two grooves are disposed on the tooth structure. The at least two ring elements are disposed on the at least two grooves, respectively.

### RELATED APPLICATIONS

This application claims priority to U.S. Provisional Application Ser. No. 63/084,576, filed Sep. 29, 2020, which is herein incorporated by reference.

### BACKGROUND

### Technical Field

The present disclosure relates to a sleeve. More particularly, the present disclosure relates to a sleeve with at least two ring elements.

### Description of Related Art

At present, there are many sleeves which are convenient for users to operate on the market. The conventional sleeve has different structures in the inner wall so as to improve the clamping capability for the sleeve to clamp a tool. However, how to improve the stability of the sleeve clamping the tool is still the direction of relevant industry efforts.

In view of this, a sleeve that can improve the stability of user during operation is still the goal pursued by relevant industry.

### SUMMARY

According to an aspect of the present disclosure, a sleeve includes a sleeve body, at least two grooves and at least two ring elements. The sleeve body has a central axis, and includes an opening and a tooth structure. The tooth structure is disposed around an inner wall of the sleeve body. The at least two grooves are disposed on the tooth structure. A minimum distance between one of the at least two grooves closest to the opening and the opening along the central axis is 1 mm-6 mm. The at least two ring elements are disposed in the at least two grooves, respectively.

### BRIEF DESCRIPTION OF THE DRAWINGS

The present disclosure can be more fully understood by reading the following detailed description of the embodiment, with reference made to the accompanying drawings as follows:

FIG. 1 shows a three-dimensional exploded view of a sleeve according to a first embodiment of the present disclosure.

FIG. 2 shows a cross-sectional view of the sleeve according to the first embodiment in FIG. 1.

FIG. 3 shows a cross-sectional view of a ring element along a sectional line 3-3 according to the first embodiment in FIG. 1.

FIG. 4 shows a cross-sectional view of a ring element in the sleeve according to a second embodiment of the present disclosure.

FIG. 5 shows a cross-sectional view of a ring element in the sleeve according to a third embodiment of the present disclosure.

FIG. 6 shows a cross-sectional view of a ring element in the sleeve according to a fourth embodiment of the present disclosure.

FIG. 7 shows a cross-sectional view of a ring element in the sleeve according to a fifth embodiment of the present disclosure.

FIG. 8 shows a three-dimensional exploded view of a sleeve according to a sixth embodiment of the present disclosure.

FIG. 9 shows a cross-sectional view of the sleeve according to the sixth embodiment in FIG. 8.

### DETAILED DESCRIPTION

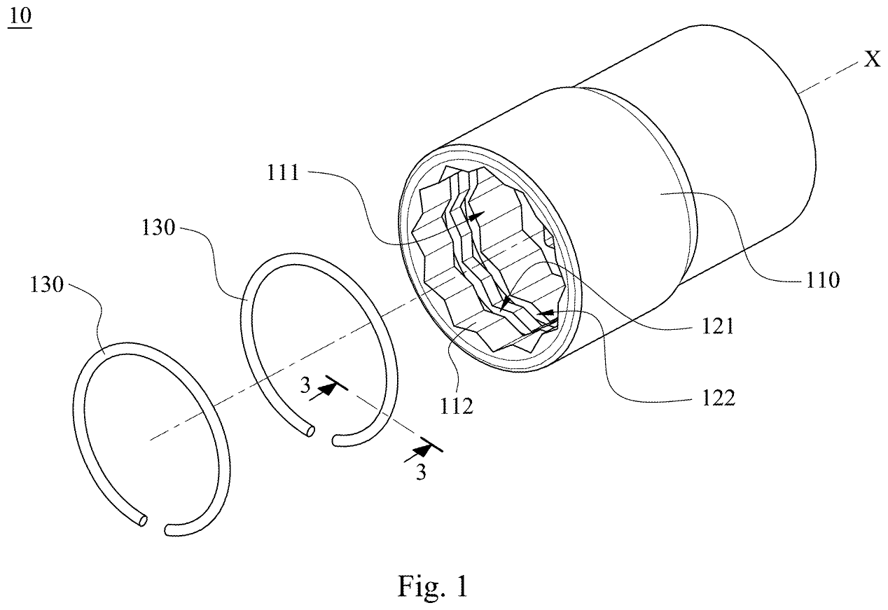

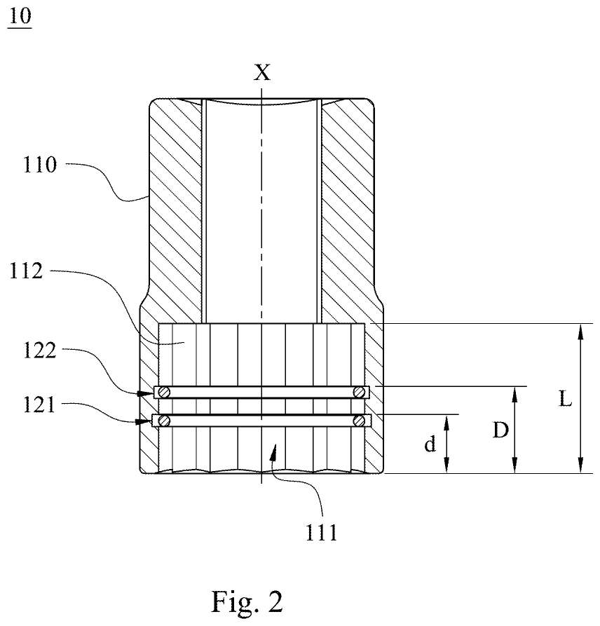

Please refer to FIGS. 1 and 2. FIG. 1 shows a three-dimensional exploded view of a sleeve 10 according to a first embodiment of the present disclosure. FIG. 2 shows a cross-sectional view of the sleeve 10 according to the first embodiment in FIG. 1. In FIGS. 1 and 2, the sleeve 10 includes a sleeve body 110, at least two grooves and at least two ring elements 130. The sleeve body 110 has a central axis X, and includes an opening 111 and a tooth structure 112. The tooth structure 112 is disposed around an inner wall of the sleeve body 110. The grooves are disposed on the tooth structure 112, and the ring elements 130 are disposed in the grooves, respectively. In the first embodiment, a number of the at least two grooves can be two which are a first groove 121 and a second groove 122, but the present disclosure is not limited thereto. A minimum distance d between one of the at least two grooves closest to the opening 111 (i.e., the first groove 121) and the opening 111 along the central axis X is 1 mm-6 mm.

In response to determine that a tool (not shown) is inserted into the sleeve body 110 from the opening 111, the minimum distance d between the first groove 121 and the opening 111 along the central axis X is favorable for improving the stability of the ring elements 130 clamping the tool through the arrangement of the grooves and the ring elements 130. Therefore, the stability of user using the sleeve 10 can be improved.

Furthermore, the minimum distance d between the one of the at least two grooves closest to the opening 111 (i.e., the first groove 121) and the opening 111 along the central axis X is 1 mm-2 mm. Therefore, it is favorable to the ring elements 130 for clamping the tool.

In FIG. 2, a maximum distance D between one of the at least two grooves farthest from the opening 111 (i.e., the second groove 122) and the opening 111 along the central axis X is smaller than or equal to half a length L of the tooth structure 112. Therefore, a space between the ring elements 130 disposed in the grooves is not too large, thereby maintaining the stability of the ring elements 130 clamping the tool.

In detail, a cross section of at least one of the at least two ring elements 130 can be a polygon or a circle. Please refer to FIG. 3. FIG. 3 shows a cross-sectional view of the ring element 130 along a sectional line 3-3 according to the first embodiment in FIG. 1. In the first embodiment, a number of the at least two ring elements 130 is two, and the cross sections of the two ring elements 130 are both circular. Therefore, the uniformity of the ring element 130 clamping tool can be increased.

Moreover, the two ring elements 130 can be a C-shaped buckle, but the present disclosure is not limited thereto. Therefore, it is favorable for assembling the ring elements 130.

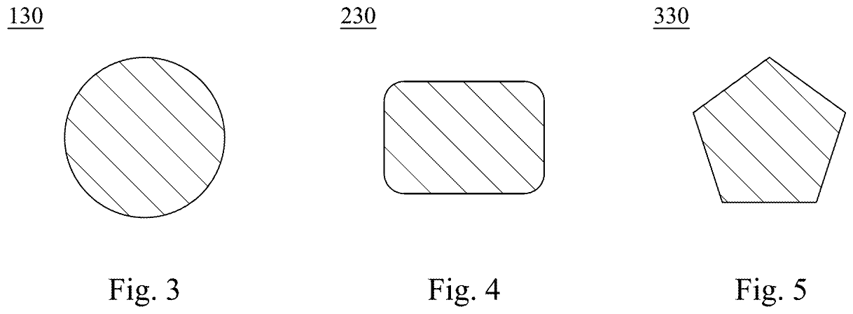

Please refer to FIG. 4. FIG. 4 shows a cross-sectional view of a ring element 230 in the sleeve according to a second embodiment of the present disclosure. In the second embodiment, the sleeve (not shown) includes a sleeve body (not shown), at least two grooves (not shown) and at least two ring elements 230. The sleeve body, the grooves, and the ring elements 230 in the second embodiment have the same structure and arranging relationship as the sleeve body 110, the grooves, and the ring elements 130 in the first embodiment, and will not be described again herein. Specifically, a cross section of the ring element 230 can be a polygon. In detail, the cross section of the ring element 230 can be a rectangle. Therefore, the present disclosure can provide the ring elements with different shapes according to the requirements of the tools.

Please refer to FIG. 5. FIG. 5 shows a cross-sectional view of a ring element 330 in the sleeve according to a third embodiment of the present disclosure. In the third embodiment, the sleeve (not shown) includes a sleeve body (not shown), at least two grooves (not shown) and at least two ring elements 330. The sleeve body, the grooves, and the ring elements 330 in the third embodiment have the same structure and arranging relationship as the sleeve body 110, the grooves, and the ring elements 130 in the first embodiment, and will not be described again herein. Specifically, a cross section of the ring element 330 can be a polygon. In detail, the cross section of the ring element 330 can be a pentagon. Therefore, the present disclosure can provide the ring elements with different shapes according to the requirements of the tools.

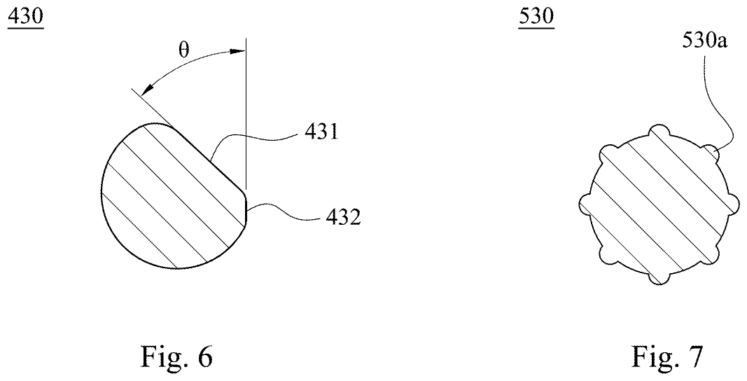

Please refer to FIG. 6. FIG. 6 shows a cross-sectional view of a ring element 430 in the sleeve according to a fourth embodiment of the present disclosure. In the fourth embodiment, the sleeve (not shown) includes a sleeve body (not shown), at least two grooves (not shown) and at least two ring elements 430. The sleeve body, the grooves, and the ring elements 430 in the fourth embodiment have the same structure and arranging relationship as the sleeve body 110, the grooves, and the ring elements 130 in the first embodiment, and will not be described again herein. Specifically, a cross section of at least one of the at least two ring elements 430 can include a first planar surface 431 and a second planar surface 432, and an angle θ is located between the first planar surface 431 and the second planar surface 432. In the fourth embodiment, a number of the at least two ring elements 430 is two, and each of the ring elements 430 includes the first planar surface 431 and the second planar surface 432.

In FIG. 6, the angle θ located between the first planar surface 431 and the second planar surface 432 can be 10 degrees-50 degrees. In the fourth embodiment, the angle θ located between the first planar surface 431 and the second planar surface 432 is 47.1 degrees, but the present disclosure is not limited thereto. In response to determine that the ring element 430 clamps a tool, the first planar surface 431 is slightly deformed by the pressing of the tool through disposing the first planar surface 431 and the second planar surface 432 toward the central axis of the sleeve body, thereby increasing a surface area in contact with the tool, so that the friction between the ring elements 430 and the tool can be increased. Therefore, the stability of the ring elements 430 clamping the tool can be improved.

Furthermore, the ring elements 430 can be made of silicon chromium steel, but the present disclosure is not limited thereto. Therefore, the abrasion resistance of the ring elements 430 can be increased.

Please refer to FIG. 7. FIG. 7 shows a cross-sectional view of a ring element 530 in the sleeve according to a fifth embodiment of the present disclosure. In the fifth embodiment, the sleeve (not shown) includes a sleeve body (not shown), at least two grooves (not shown) and at least two ring elements 530. The sleeve body, the grooves, and the ring elements 530 in the fifth embodiment have the same structure and arranging relationship as the sleeve body 110, the grooves, and the ring elements 130 in the first embodiment, and will not be described again herein. Specifically, at least one of the at least two ring elements 530 can include a plurality of protruding structures 530a, and the protruding structures 530a are protruded from a surface of the at least one of the at least two ring elements 530. The surface area in contact with the tool can be increased through the arrangement of the protruding structures 530a, so that the friction between the ring elements 530 and the tool is increased.

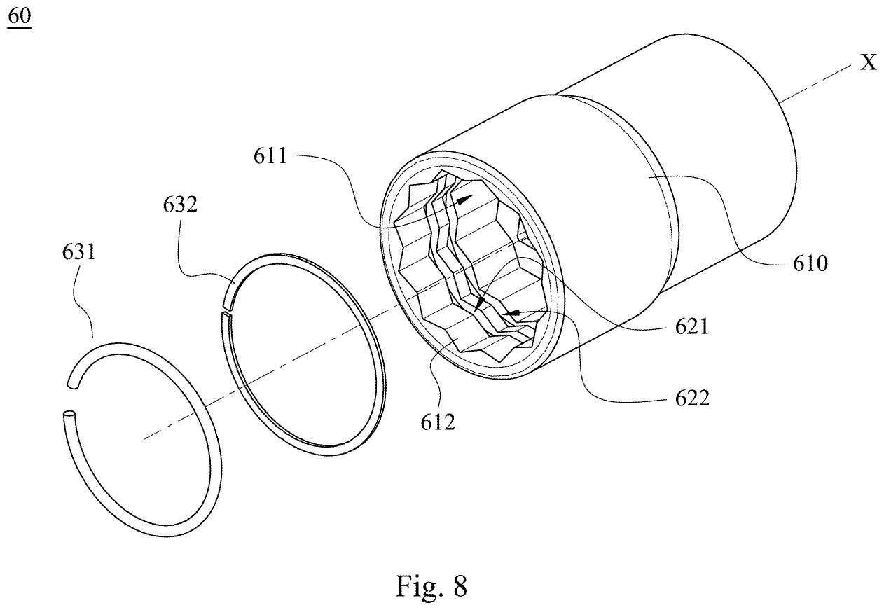

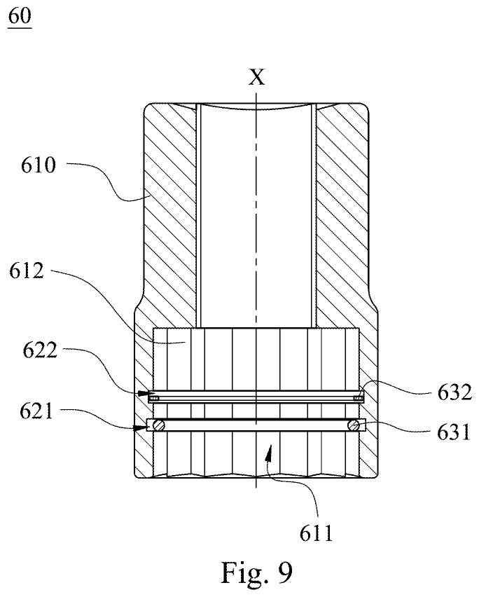

Please refer to FIGS. 8 and 9. FIG. 8 shows a three-dimensional exploded view of a sleeve 60 according to a sixth embodiment of the present disclosure. FIG. 9 shows a cross-sectional view of the sleeve 60 according to the sixth embodiment in FIG. 8. In FIGS. 8 and 9, the sleeve 60 includes a sleeve body 610, at least two grooves (its reference numeral is omitted) and at least two ring elements (its reference numeral is omitted). The sleeve body 610 has a central axis X, and includes an opening 611 and a tooth structure 612. The tooth structure 612 is disposed around an inner wall of the sleeve body 610. The grooves are disposed on the tooth structure 612, and the ring elements are disposed in the grooves, respectively. In the sixth embodiment, a number of the at least two grooves can be two which are a first groove 621 and a second groove 622, but the present disclosure is not limited thereto. A minimum distance (its reference numeral is omitted) between one of the at least two grooves closest to the opening 611 (i.e., the first groove 621) and the opening 611 along the central axis X is 1 mm-6 mm.

Furthermore, a number of the at least two ring elements can be two which are a first ring element 631 and a second ring element 632. A cross section of one of the at least two ring elements farthest from the opening 611 (i.e., the second ring element 632) can be a rectangle, and a length of the cross section of the one of the at least two ring elements is perpendicular to the central axis X. Moreover, a cross section of one of the at least two ring elements closest to the opening 611 (i.e., the first ring element 631) can be a circle, but the present disclosure is not limited thereto. In response to determine that a tool (not shown) is inserted into the sleeve body 610 from the opening 611, the sleeve 60 can clamp the tool via the first ring element 631 and block the tool via the second ring element 632 through the arrangement of the first ring element 631 and the second ring element 632, so that the stability of user using the sleeve 60 is improved.

The features such as the numbers and structures of the ring elements in the first to sixth embodiments disclosed in the present disclosure can be combined and configured according to the requirements of different sleeves to achieve corresponding effects.

In summary, the sleeve provided by the present disclosure has the following advantages. First, the stability of the ring element clamping tool can be effectively improved through the arrangement of the grooves and the ring elements relative to the opening. Second, it is favorable for providing the ring elements with different shapes to increase the friction between the ring elements and the tool. Third, the tool can be clamped and blocked at the same time through the ring elements with different shapes, thereby improving the stability of the sleeve during operation.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A sleeve, comprising:
a sleeve body having a central axis, and comprising:
an opening; and
a tooth structure disposed around an inner wall of the sleeve body;
at least two grooves disposed on the tooth structure, wherein a minimum distance between one of the at least two grooves closest to the opening and the opening along the central axis is 1 mm-6 mm; and
at least two ring elements disposed in the at least two grooves, respectively.

2. The sleeve of claim 1, wherein the minimum distance between the one of the at least two grooves closest to the opening and the opening along the central axis is 1 mm-2 mm.

3. The sleeve of claim 1, wherein a maximum distance between one of the at least two grooves farthest from the opening and the opening along the central axis is smaller than or equal to half a length of the tooth structure.

4. The sleeve of claim 1, wherein a cross section of at least one of the at least two ring elements is a polygon or a circle.

5. The sleeve of claim 1, wherein a cross section of at least one of the at least two ring elements comprises a first planar surface and a second planar surface, and an angle is located between the first planar surface and the second planar surface.

6. The sleeve of claim 5, wherein the angle located between the first planar surface and the second planar surface is 10 degrees-50 degrees.

7. The sleeve of claim 1, wherein at least one of the at least two ring elements comprises a plurality of protruding structures, and the protruding structures are protruded from a surface of the at least one of the at least two ring elements.

8. The sleeve of claim 1, wherein each of the at least two ring elements is a C-shaped buckle.

9. The sleeve of claim 1, wherein a number of the at least two ring elements is two, a cross section of one of the at least two ring elements farthest from the opening is a rectangle, and a length of the cross section of the one of the at least two ring elements is perpendicular to the central axis.

10. The sleeve of claim 1, wherein each of the at least two ring elements is made of silicon chromium steel.
